(19) United States
(12) Patent Application Publication
(10) Pub. No.: US 2010/0299270 A1
(43) Pub. Date: Nov. 25, 2010

(54) SYSTEM AND METHOD FOR ENERGY DEVICE ACTIVATION

(76) Inventor: Chad L. Maglaque, Seattle, WA (US)

Correspondence Address: K&L GATES LLP, 210 SIXTH AVENUE, PITTSBURGH, PA, 15222-2613, US

(21) Appl. No.: 12/783,407

(22) Filed: May 19, 2010

Related U.S. Application Data
(60) Provisional application No. 61/179,379, filed on May 19, 2009.

(51) Int. Cl. G06Q 10/00; G06Q 20/00; G06F 1/26

(52) U.S. Cl. 705/80; 705/8; 700/297; 713/300

(57) ABSTRACT

A system for providing an energy device activation service is disclosed. The system includes one or more network-enabled energy devices and an energy management interface comprising at least one processor. The energy management interface is to establish a network connection with each one of the one or more energy devices via a first communication network, establish a network connection with an energy device activation service via a second communication network, query the one or more energy devices to receive at least one of an operational parameter and a capability from each one of the one or more energy devices, and transmit the at least one of an operational parameter and a capability to a first database of the energy device activation service. The energy management interface is also to determine if each one of the one or more energy devices is an approved energy device based on energy device information stored in a second database of the energy device activation service, determine if each one of the one or more energy devices is eligible for activation based on at least one business rule stored in a third database of the energy device activation service, retrieve a contract from a fourth database of the energy device activation service when at least one of the one or more energy devices is determined to be an approved energy device that is eligible for activation, and activate the at least one approved and eligible energy device to enable at least one of an energy generation feature and an energy consumption feature of the at least one approved and eligible energy device when an acceptance of the contract is received by the energy management interface.

### CROSS REFERENCE TO RELATED APPLICATIONS

This application claims priority from the U.S. Provisional Patent Application Ser. No. 61/179,379 filed May 19, 2009, the disclosure of which is attached at Appendix A hereto and incorporated herein by reference. The disclosure of related U.S. Nonprovisional patent application Ser. No. 12/712,166 filed Feb. 24, 2010 is incorporated herein by reference.

### BACKGROUND

Although wind and water power represent two of the more abundant sources of renewable energy, few of the systems available today for harvesting energy from such resources are practical or affordable, especially for many households and developing communities seeking to make an initial investment in renewable energy. Turn-key systems typically cost thousands of dollars, are difficult to install, and are of limited scalability. Affordable fluid-driven power generation appliances that are also quiet, reliable, safe and easily installable are therefore desirable.

Additionally, applying for and receiving approval to connect an energy device, such as a fluid-driven power generation appliance or other energy-generating device, or an energy-consuming device, to a commercial energy service may be a difficult (and sometimes unnecessary) process that is often based on inaccurate or outdated business rules. Moreover, although energy generation incentives and secondary energy markets may exist, consumers may lack the mechanisms necessary for participating in or otherwise accessing such benefits.

### SUMMARY

A power generation apparatus is disclosed. In one embodiment, the apparatus includes a turbine rotor to generate mechanical energy from a flow of a fluid, an induction generator or coupled to the turbine rotor to convert the mechanical energy into electrical energy, a fluid speed sensor to output a fluid speed signal indicative of a speed of the fluid flow, and a controller electrically coupled to the induction generator and to the fluid speed sensor. The apparatus may include a nacelle to contain the induction generator and the controller. The controller includes at least one processor programmed to determine, based on the fluid speed signal, when the speed of the fluid flow exceeds a minimum speed sufficient for operation of the turbine rotor, initiate operation of the induction generator when the fluid flow speed exceeds the minimum speed by causing electrical power from a power source to be applied to a stator of the induction generator, and monitor a flow of electrical power between the stator of the induction generator and the power source to determine when the induction generator is supplying electrical power to the power source.

In one embodiment, the turbine rotor includes a vertical-axis turbine (VAT) rotor. The turbine rotor may be a Darrieus turbine rotor or a Gorlov turbine rotor, for example.

In one embodiment, the turbine rotor may be configured to be driven by air. In another embodiment, the turbine rotor may be configured to be driven by water.

In one embodiment, the apparatus includes an electrical connector to couple the induction generator to an electrical socket. The electrical socket may be coupled to an electrical distribution network managed by a public utility company, for example.

In one embodiment, the processor(s) of the controller may be programmed to monitor one or more of: the speed of the fluid flow, the flow of electrical power between the stator of the induction generator and the power source, a speed of the induction generator and a temperature of the induction generator to determine at least one operating characteristic of the induction generator. The processor(s) of the controller may also be programmed to modify an operating speed of the induction generator based on at least one of: the operating characteristic(s) and at least one power curve. Modification of an operating speed of the induction generator may include changing a pole count of the induction generator, in one embodiment.

In one embodiment, the processor(s) of the controller may be programmed to detect a shutdown condition of at least one of the turbine rotor and the induction generator and to cause direct current (DC) electrical power to be applied to the stator of the induction generator when a shutdown condition is detected. The DC power may be applied for a duration sufficient to stop rotational movement of the turbine rotor and a rotor of the induction generator.

In one embodiment, the processor(s) of the controller may be programmed to determine when at least one of the speed of the fluid flow and a speed of the turbine rotor exceeds a corresponding maximum operating speed, and to cause direct current (DC) electrical power to be applied to the stator of the induction generator when a maximum operating speed is exceeded. The DC electrical power may be applied for a duration sufficient to stop rotation of the turbine rotor and a rotor of the induction generator in a first direction. The processor(s) of the controller may also be programmed to cause electrical power from the power source to be applied to the stator of the induction generator to start rotation of the turbine rotor and the rotor of the induction generator in a second direction, the second direction being opposite the first direction.

In one embodiment, the apparatus includes at least one of a wired communication port and a wireless communication adaptor in communication with the controller to establish a communication link between the controller and a east one process-based device external to the apparatus.

Embodiments of a vertical-axis turbine (VAT) rotor are also disclosed. In one embodiment, the VAT rotor includes a rotor blade including a first end. The VAT rotor may also include a rotor arm attached to the first end of the rotor blade, and at least one rotor blade fastener shim disposed on a single side or on opposite sides of the first end of the rotor blade. The rotor blade fastener shim(s) may be shaped to introduce a pitch to the rotor blade. In one embodiment, the rotor arm is removably attached to the first end of the rotor blade to enable adjustment of the rotor blade pitch by addition or removal of the rotor blade fastener shim(s).

In another embodiment, the VAT rotor includes a first rotor blade including a first end. The VAT rotor may also include a first rotor blade fastener plate to receive the first end of the first rotor blade, and a rotor blade faster plate seat including a first surface and a second surface. The first surface may receive the first rotor blade fastener plate, and the second surface may be attached to a rotor arm. In one embodiment, the first rotor blade fastener plate is removably received by the first surface of the rotor blade faster plate seat to enable replacement of the first rotor blade and the first rotor blade fastener plate by a second rotor blade and a corresponding second rotor blade fastener plate. The second rotor blade may be shaped differently than the first rotor blade.

A method of operating a power generation apparatus including a fluid-driven turbine rotor and an induction generator coupled to the turbine rotor is also disclosed. The induction generator may convert mechanical energy generated by the turbine rotor into electrical energy. In one embodiment, the method is performed by a processor-based controller and includes determining when the speed of a fluid flow for driving the turbine rotor exceeds a minimum speed sufficient for operation of the turbine rotor, initiating operation of the induction generator when the fluid flow speed exceeds the minimum speed by causing electrical power from a power source to be applied to a stator of the induction generator, and monitoring a flow of electrical power between the stator or of the induction generator and the power source to determine when the induction generator is supplying electrical power to the power source.

In one embodiment, the method includes monitoring one or more of: the speed of the fluid flow, the flow of electrical power between the stator of the induction generator and the power source, a speed of the induction generator and a temperature of the induction generator to determine at least one operating characteristic of the induction generator, and modifying an operating speed of the induction generator based on at least one of: the operating characteristic(s) and at least one power curve. Modifying an operating speed of the induction generator may include changing a pole count of the induction generator in one embodiment.

In one embodiment, the method includes detecting a shutdown condition of at least one of the turbine rotor and the induction generator, and causing direct current (DC) electrical power to be applied to the stator of the induction generator when a shutdown condition is detected. The DC power may be applied for a duration sufficient to stop rotational movement of the turbine rotor and a rotor of the induction generator.

In one embodiment, the method includes determining when at least one of the speed of the fluid flow and a speed of the turbine rotor exceeds a corresponding maximum operating speed, and causing direct current (DC) electrical power to be applied to the stator of the induction generator when a maximum operating speed is exceeded. The DC electrical power may be applied for a duration sufficient to stop rotation of the turbine rotor and a rotor of the induction generator in a first direction. The method my also include causing electrical power from the power source to be applied to the stator of the induction generator to start rotation of the turbine rotor and the rotor of the induction generator in a second direction, the second direction being opposite the first direction.

In one embodiment, the method includes receiving, by the processor-based controller, configuration data from a processor-based device remotely located with respect to the power generation apparatus. The configuration data may include at least one of: a start up speed, a cut off speed, and an operational profile.

A system for providing an energy device activation service is also disclosed. In one embodiment, the system includes one or more network-enabled energy devices and an energy management interface comprising at least one processor. The energy management interface is to establish a network connection with each one of the one or more energy devices via a first communication network, establish a network connection with an energy device activation service via a second communication network, query the one or more energy devices to receive at least one of an operational parameter and a capability from each one of the one or more energy devices, and transmit the at least one of an operational parameter and a capability to first database of the energy device activation service. The energy management interface is also to determine if each one of the one or more energy devices is an approved energy device based on energy device information stored in a second database of the energy device activation service, determine if each one of the one or more energy devices is eligible for activation based on at least one business rule stored in a third database of the energy device activation service, retrieve a contract from a fourth database of the energy device activation service when at least one of the one or more energy devices is determined to be an approved energy device that is eligible for activation, and activate the at least one approved and eligible energy device to enable at least one of an energy generation feature and an energy consumption feature of the at least one approved and eligible energy device when an acceptance of the contract is received by the energy management interface.

In one embodiment, the one or more network-enabled energy devices and the energy management interface are located within a premises, and the energy device activation service is located externally with respect to the premises.

In one embodiment, the first network includes a premises area network, and the second network includes the Internet.

In one embodiment, the energy management interface is to create and manage an account associated with the one or more network-enabled energy devices. The account may include consumer data stored in a fifth database of the energy device activation service.

In one embodiment, the system includes an energy service provider management interface in communication with the energy management interface and the energy device activation service via the second communication network. The energy service provider management interface includes at least one processor and may be used to enter, edit or delete information stored in any of the first, second, third, fourth and fifth databases. The energy service provider management interface may also be used to retrieve, view or print an inventory of the one or more network-enabled energy devices.

In one embodiment, the system may include the energy device activation service.

In one embodiment, the system may include an energy service, and the energy service may include the energy device activation service.

In one embodiment, the first database includes data identifying one or more network-enabled energy devices connected to the energy service.

In one embodiment, the second database includes data identifying one or more network-enabled energy devices eligible for connection to the energy service.

In one embodiment, the at least one business rule includes a plurality of business rules, with the plurality of business rules including at least one of a business rule specifying one or more energy devices, or one or more classes of energy devices, connectable to the energy service, a business rule specifying an energy rating requirement of energy devices connectable to the energy service, and a business rule specifying a number of energy devices connectable to the energy service based on at least one of a premises, a property, a distribution point, an energy service and a system operator.

In one embodiment, the fourth database includes at least one of a terms of use agreement, an end-user license agreement, a service contract and a connection agreement.

In one embodiment, the fifth database includes at least one of a consumer name, a consumer username, a consumer password, a consumer e-mail address, a consumer telephone number and a consumer address.

In one embodiment, the energy management interface is to activate each one of the one or more energy devices by setting an activation flag, setting an activation expiration date to a specified date in the future, or granting an operational certificate including an expiration date and an operational privilege.

In one embodiment, the energy management interface is to deactivate at least one of the one or more energy devices.

A method for providing an energy device activation service is also disclosed. In one embodiment, the method includes establishing, by a energy management interface including at least one processor, a network connection between the energy management interface and one or more energy devices via a first communication network, establishing, by the energy management interface, a network connection between the energy management interface and an energy device activation service via a second communication network, querying, by the energy management interface, the one or more energy devices to cause the energy management interface to receive at least one of an operational parameter and a capability from each one of the one or more energy devices, and transmitting, by the energy management interface, the at least one of an operational parameter and a capability to a first database of the energy device activation service. The method further includes determining, by the energy management interface, if each one of the one or more energy devices is an approved energy device based on energy device information stored in a second database of the energy device activation service, determining, by the energy management interface, if each one of the one or more energy devices is eligible for activation based on at least one business rule stored in a third database of the energy device activation service, retrieving, by the energy management interface, a contract from a fourth database of the energy device activation service when at least one of the one or more energy devices is determined to be an approved energy device that is eligible for activation, and activating the at least one approved and eligible energy device to enable at least one of an energy generation feature and an energy consumption feature of the at least one approved and eligible energy device when an acceptance of the contract is received by the energy management interface.

In one embodiment, the method includes creating and managing, by the energy management interface, an account associated with the one or more network-enabled energy devices. The account may include data stored in a fifth database of the energy device activation service.

In one embodiment, activating the at least one approved and eligible energy device includes setting an activation flag, setting an activation expiration date to a specified date in the future, or granting an operational certificate including an expiration date and an operational privilege.

In one embodiment, the method includes deactivating, by the energy management interface, at least one of the one or more energy devices.

In one embodiment, determining if each one of the one or more energy devices is eligible for activation based on at least one business rule includes determining based on at least one of a business rule specifying one or more energy devices, or one or more classes of energy devices, connectable to the energy service, a business rule specifying an energy rating requirement of energy devices connectable to the energy service, and a business rule specifying a number of energy devices connectable to the energy service based on at least one of a premises, a property, a distribution point, an energy service and a system operator.

### DESCRIPTION OF THE FIGURES

Various embodiments of the present invention are described herein by way of example in conjunction with the following figures, wherein:

FIGS. 1A, 1B and 1C are views of an apparatus for generating electrical power from a flow of a fluid according to one embodiment;

FIGS. 1D and 1E illustrate a turbine rotor according to one embodiment;

FIG. 2 illustrates a component arrangement of an apparatus for generating electrical power from a flow of a fluid according to one embodiment;

FIGS. 3 and 4 illustrate rotor blade fastener arrangements according to various embodiments;

FIG. 5 illustrates a horizontal-axis turbine power curve;

FIG. 6 illustrates a vertical-axis turbine power curve according to one embodiment;

FIG. 7 illustrates vertical-axis turbine angle of attack curves according to various embodiments;

FIG. 8 illustrates a power output curve according to one embodiment;

FIG. 9 is a tabulation of synchronous speeds for an induction generator;

FIG. 10 is a tabulation of tip speed ratios at 1% generator slip;

FIG. 11 is a tabulation of tip speed ratios at 20% generator slip;

FIG. 12 illustrates a system for implementing an activation service according to one embodiment;

FIG. 13 illustrates communication between an energy device and an energy management interface according to one embodiment;

FIG. 14 illustrates a listing of operational parameters and device capabilities returned by an energy device according to one embodiment;

FIG. 15 illustrates a premises area network according to one embodiment;

FIG. 16 illustrates an energy device activation workflow according to one embodiment; and

FIG. 17 illustrates a computing device according to one embodiment.

### DESCRIPTION

Various embodiments of an apparatus for generating power from a flow of a fluid are described herein. As used herein, the term “fluid” refers to a continuous, amorphous substance having molecules that move freely past one another, and having a tendency to assume the shape of its container. In various embodiments, for example, the fluid may be a liquid (e.g., water) or a gas (e.g., air). Embodiments of the apparatus may comprise a turbine rotor mechanically coupled to an induction generator for converting mechanical energy generated from the fluid flow into electrical energy in a manner that is affordable, quiet, reliable and safe relative to known fluid-driven power generation systems. Embodiments of the apparatus may be easily installed by connection to an existing electrical outlet or socket (e.g., an electrical outlet or socket coupled to an electrical distribution network managed by a public utility company) without a need for special wiring or additional hardware. Accordingly, considerable operational and installation savings may be realized. Operational savings also may be realized by the use of an induction generator, which is highly reliable, requires little maintenance (e.g., no contact brushes requiring replacement) and is available at relatively low cost. Embodiments of induction generators may be operated at various speeds and controlled to address overload conditions. In certain embodiments, for example, the number of active poles of the induction generator may be changeable on the fly (e.g., during operation of the induction generator) in order to alter its operating speed and torque characteristics. Such embodiments of the induction generator, as well as others, are well-suited for handling fluctuations in turbine rotor speed caused by changes in fluid speed. Additionally, in cases in which the stator of the induction generator is powered from an external electrical network (e.g., from an electrical distribution network managed by a public utility company), a loss of external power (e.g., due to a weather-related power outage) will cause the induction generator to stop generating electricity, even when mechanical energy continues to be supplied to the induction generator. This inherent anti-islanding feature of induction generators does not require special wiring or controls and serves to protect utility workers by preventing the introduction of electrical power to external electrical networks during a power loss.

In various embodiments, the turbine rotor may comprise a fluid-driven vertical-axis turbine rotor, and the induction generator may be a horizontally mounted multi-pole variable-speed induction generator. In one embodiment, a vertical axis turbine (VAT) rotor comprises a turbine rotor having an axis of rotation that is substantially non-parallel to the direction of fluid flow. For example, when the direction of the fluid flow is fixed, such as a river, the VAT rotor axis of rotation may be vertical or horizontal but not parallel to the river's flow. In one embodiment, the apparatus may comprise a processor-based controller in communication with a number of electronic sensors and connected to the induction generator to manage the overall operation of the apparatus. In the case of wind power, the apparatus may be mounted on rooftops, towers or even existing utility poles and street lights. In the case of water power, the apparatus may be mounted to a river or sea bed, floating platform or rigid structure. It will be appreciated that such embodiments of the apparatus provide an affordable option for many households and developing communities seeking to harness wind and water power. Additionally, because VAT rotors operate independent of fluid direction, the apparatus may be able to harvest more energy than conventional horizontal-axis turbine (HAT) configurations.

Moreover, embodiments of the apparatus may be controlled remotely by the user or a third party (such as a public utility company) by either wired or wireless communication in order to change/modify operational aspects (e.g., power output) of the apparatus, either on an individual basis or as part of a larger distributed power generation network.

Also described herein are various embodiments of an energy device activation system and method for providing detailed real-time information regarding requirements for connecting a network-enabled energy device to a commercial energy service and streamlining steps (e.g., agreements and approvals) necessary to enable the connection. The term “energy device” as used herein includes without limitation an energy generating device, an energy consuming device or a hybrid energy generating-consuming device such as a battery storage device or other energy storage device. The term “energy generating device” as used herein includes without limitation any device (e.g., a fluid-driven turbine, a solar panel, a hydro-electric generator, a battery storage device, a flywheel, a fuel cell, a gas reformer) suitable for converting kinetic or potential energy (e.g., chemical energy, gravitational energy, mechanical energy, nuclear energy, thermal energy, light energy, EMF, kinematic energy, sound energy) into energy (e.g., electrical energy or chemical energy) that may be used, for example, in commercial or residential applications. The term “energy consuming device” as used herein includes without limitation any device (e.g., a motor, a light bulb, a heater, a radio, a battery charger) that converts energy (e.g., electrical energy or chemical energy) available from, for example, commercial or residential energy sources, into kinetic or potential energy. The term “commercial energy service” as used herein refers to a source of energy for a premises, including without limitation electrical or natural gas distribution networks managed by public utility companies or other entities. The term “premises” as used herein includes without limitation any permanent or temporary, stationary or mobile, structure used or intended for supporting or sheltering any use or occupancy. Examples of premises include without limitation residential homes, commercial buildings, temporary shelters, vehicles, watercraft, airplanes and spacecraft. The term “premises area network” (PAN) as used herein refers to an energy-related network used for communicating with devices within a premises. A PAN may be connected to one or more communication networks external to a premises, but does not necessarily require connectivity outside the premises.

Embodiments of the energy device activation system and method enable consumers to register, activate and connect network-enabled energy devices to a commercial energy service and, by virtue of the connection, participate in or otherwise access energy generation incentives, secondary energy markets and other benefits, either directly or indirectly though an energy service provider. The term “consumer” as used herein refers to either a person or entity that consumes resources, including without limitation electricity, natural gas, water, or other resources. The term “energy service provider” as used herein refers to an entity which provides energy services to consumers, including without limitation electric and gas utilities, retail electric and gas providers, energy management service providers and energy service aggregators. The term “energy service” as used herein includes without limitation commercial energy services, energy management services and energy aggregation services. Embodiments of the energy device activation system and method also enable energy service providers to develop a complete inventory of network-enabled energy devices connected to their respective services and to set and define business rules that dictate, for example, how and how many network-enabled energy devices may connect to a service for a given consumer, a given property, a given distribution point (such as an electrical transformer or electrical substation) or a given energy service.

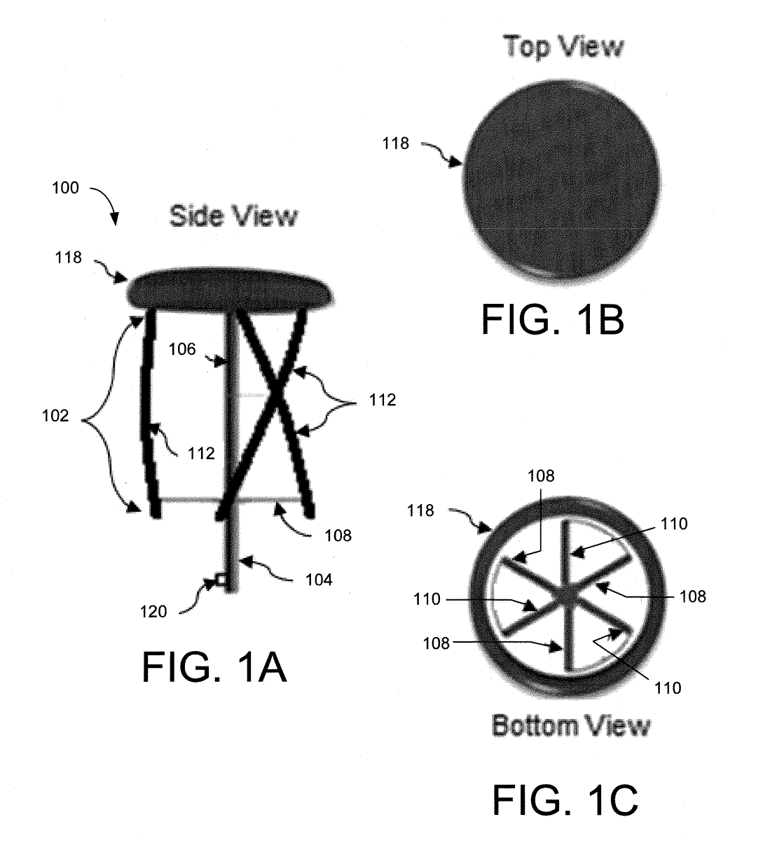

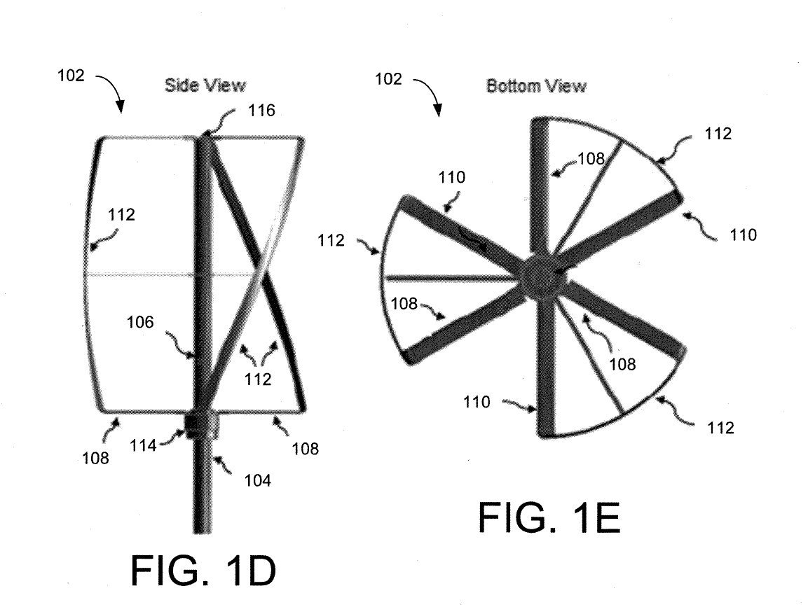

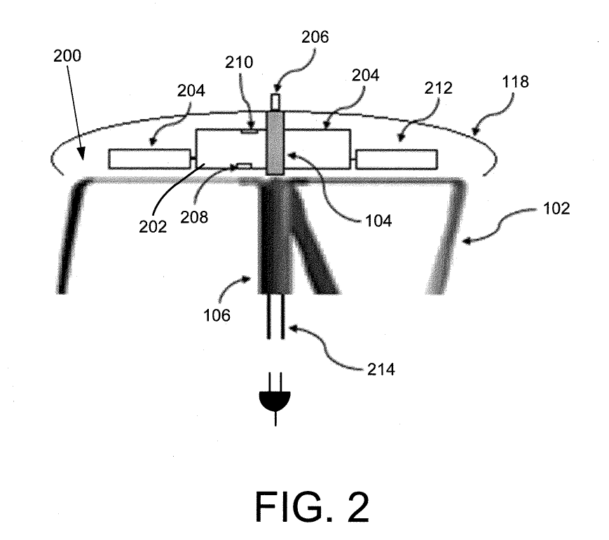

FIGS. 1A, 1B and 1C illustrate side, top and bottom views, respectively, of an apparatus 100 for generating electrical power from a flow of a fluid, according to one embodiment. In the illustrated embodiment, the apparatus 100 may comprise a turbine rotor 102 mounted to a turbine mast 104. The turbine rotor 102 may comprise a rotor tube 106 having one or more bottom rotor arms 108 and one or more top rotor arms 110. First ends of the bottom rotor arms 108 and top rotor arms 110 may be connected to top and bottom ends, respectively, of the rotor tube 106. In the embodiment illustrated in FIG. 1C, second ends of the bottom and top rotor arms 108, 110 may generally extend in a radial direction from the rotor tube 106. The turbine rotor 102 may further comprise one or more rotor blades 112, with each rotor blade 112 attached between the second ends of a lower and upper rotor arm 108, 110. Each rotor blade 112 may comprise foil-shaped cross-sections such that a fluid flow over the rotor blade 112 generates one or more forces (e.g., lift force, drag force) to impart rotational motion to the turbine rotor 102. Top and bottom ends of the rotor tube 106 may respectively comprise a bottom bearing 114 and a top bearing 116 (FIG. 1D) through which the turbine mast 104 is received to enable the free rotation of the turbine rotor 102 about the turbine mast 104. The apparatus 100 may further comprise a generator nacelle 118 attached to the top of the turbine mast 104. The generator nacelle 118 may be shaped to resist fluid drag and to reduce spinning drag of the rotor arms 108, 110. The generator nacelle 118 may be prevented from spinning with the turbine rotor 102 by virtue of its attachment to the turbine mast 104. A communication port 120 (e.g., a USB communication port) may be attached to the bottom of the turbine mast 104 and electrically connected by a communication cable (not shown) to a processor-based controller 204 (FIG. 2) contained within the generator nacelle 118.

In certain embodiments, the rotor blades 112, generator nacelle 118 and/or other components of the apparatus 100 may be customized to match the user's tastes, blend in with the surrounding environment, and/or comply with local ordinances and requirements. Such customization may include, for example, color (e.g., white, grey, or other non-obtrusive colors, black surfaces to facilitate de-icing), finish (e.g., matte or non-reflective coatings to reduce reflections) and signage.

In certain embodiments, the turbine rotor 102 may be a Darrieus-style turbine rotor. Darrieus-style turbine rotors are described in, for example, U.S. Pat. No. 1,835,018 to G. J. M. Darrieus, the disclosure of which is incorporated herein by reference. Darrieus-style turbine rotors generate rotation by virtue of lift forces resulting from fluid flowing over the rotor blades. Because Darrieus-style turbines may rotate faster than the fluid speed, they are particularly well-suited for electrical generation applications. Darrieus-style turbine rotors are not self-starting, however, and require an assistive starting device.

FIGS. 1D and 1E are side and top views, respectively, of a Darrieus-style turbine rotor for imparting a helical twist to the rotor blades 112 according to one embodiment. Variations of the Darrieus-style turbine rotor, including, for example, the Gorlov helical turbine (GHT), may alternatively be used.

In other embodiments, Savonius turbine rotors may be used. Savonius turbine rotors generate rotation by virtue of a drag differential and are generally more reliable and less costly than Darrieus-style turbine rotors, but less efficient. Examples of Savonius-style turbine rotors are described in U.S. Pat. No. 7,393,177 to Rahai et al., the disclosure of which is incorporated herein by reference.

In certain embodiments, foils of the rotor blades 112 may designed based on known foil shapes, such as National Advisory Committee for Aeronautics (NACA) foil shapes, for example. In certain embodiments, for example, foil shapes of the rotor blades 112 may comprise any of NACA 0015, 0018 and 0021 airfoil shapes, or variations thereof, for example.

FIG. 2 shows an interior side view of a generator compartment 200 of the apparatus 100 according to one embodiment. In the illustrated embodiment, the generator compartment 200 may be defined by the generator nacelle 118 and comprise an induction generator 202 mounted to the turbine mast 104, with the rotor of the induction generator 202 coupled to the turbine rotor 102. Electrical leads (not shown) of the induction generator 202 may be connected to a processor-based controller 204 used to manage and control operational aspects of the apparatus 100. In certain embodiments, the induction generator 202 may be a 48-pole or a 72-pole induction generator, although it will be appreciated that the number of poles may be varied based on, for example, the operational characteristics of the turbine rotor. A fluid speed sensor 206 may be attached to the top of the generator nacelle 118 and electrically connected to the processor-based controller 204 to provide fluid speed information to the processor-based controller 204. Similarly, a generator speed sensor 208 and a generator temperature sensor 210 may be attached to the induction generator 202 and electrically coupled to the processor-based controller 204 to provide induction generator 202 speed and temperature information to the processor-based controller 204. Also in communication with the processor-based controller 204 may be a wireless network adapter 212 and power supply leads 214. Power supply leads 214 may be routed down through the turbine mast 104 and configured for connection to an available power supply (e.g., a local power grid), thereby enabling the transmission of electrical power to and from the apparatus 100.

Although in the embodiments of FIGS. 1A, 1B and 1C and FIG. 2 the generator nacelle 118 is depicted as being mounted on the top of the turbine mast 104, it will be appreciated that in other embodiments the generator nacelle 118 and components contained in the generator compartment 200 may instead be mounted on the bottom of the turbine mast 104 (e.g., below the turbine rotor 102) in other embodiments. In certain embodiments, the apparatus 100 may comprise more than one induction generator 202. In one embodiment, for example, the apparatus 100 may comprise two induction generators 202, with a first induction generator 202 being mounted on top of the turbine mast 104 and a second induction, generator 202 being mounted on the bottom of the turbine mast 104. In such cases, the apparatus 100 may comprise generator nacelles 118 located on the top and bottom of the turbine mast 104, for example.

### Rotor Blade Fastener Assembly and Rotor Blade Replacement

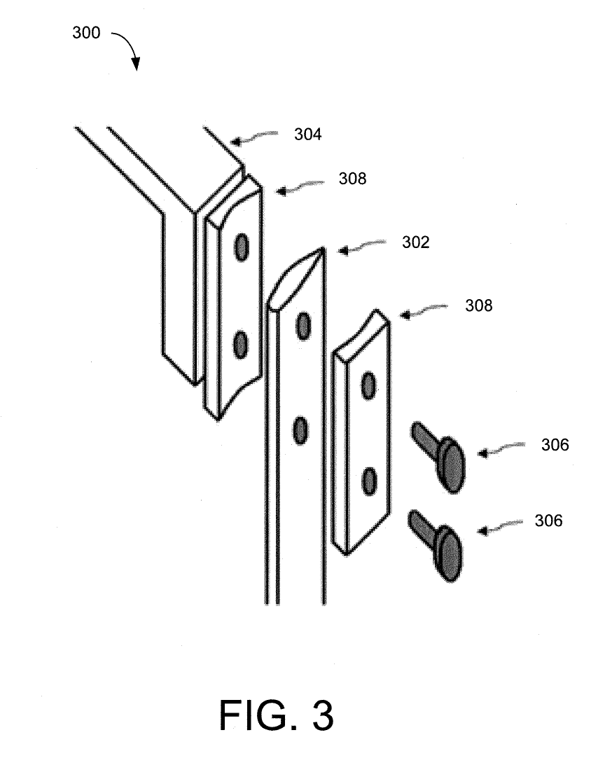

FIG. 3 shows a close up view of a rotor blade fastener assembly 300 according to one embodiment. The assembly 300 may be used in connection with a Darrieus-style turbine rotor (such as that shown in FIGS. 1C and 1D), for example. The rotor blade fastener assembly 300 comprises a rotor blade 302 fastened to a rotor arm 304 with one or more fasteners 306, and one or more rotor blade fastener shims 308 disposed on a single side, or opposing sides as shown in FIG. 3, of the rotor blade 302. Each fastener 306 may be any device for mechanically joining or affixing two or more objects together, such as, for example, a bolt, screw or cotter pin. Each rotor blade fastener shim 308 may comprises a suitable shape, profile or contour (e.g., a curved profile, a wedge-shaped profile) and may be used to adjust the pitch of the rotor blade 302 and/or to accommodate rotor blades 302 of varying profile. It will be appreciated that in certain embodiments the rotor blade 302 and the rotor arm 304 may be identical or similar to any of rotor blades 112 and rotor arms 108, 110, respectively, of the embodiments illustrated in FIGS. 1A, 1B and 1C and FIG. 2.

In the event that a rotor blade 302 needs to be replaced (e.g., due to damage) or upgraded (e.g., if a new rotor blade design is developed or different operational characteristics are desired), the user may simply remove the one or more fasteners 306 and subsequently remove the rotor blade 302 and rotor blade fastener shim(s) 308 from the rotor arm 304. The rotor blade fastener shim(s) 308 may then be removed from the rotor blade rotor blade 302 and attached to the new rotor blade 302. The user may then attach the new rotor blade 302 and rotor blade fastener shim(s) 308 to the rotor arm 304 using the one or more fasteners 306.

Although the pitch of the rotor blades 302 of the turbine rotor are generally fixed during operation, the pitch of the rotor blades 302 may be adjusted (e.g., in order to change turbine rotor operational characteristics) by replacing the rotor blade fastener shim(s) 308 with rotor blade fastener shim(s) 308 of differing shape, profile or contour. This may be accomplished, for example, by removing the one or more fasteners 306 and subsequently removing the rotor blade 302 and rotor blade fastener shim(s) 308 from the rotor arm 304. The rotor blade fastener shim(s) 308 may then be removed from the rotor blade 302, and the new rotor blade fastener shim(s) 308 (or some or all of the existing rotor blade fastener shim(s) 308 arranged in a new configuration) may be attached to the rotor blade 302. The user may then attach the rotor blade 302 and rotor blade fastener shim(s) 308 to the rotor arm 304 using the one or more fasteners 306.

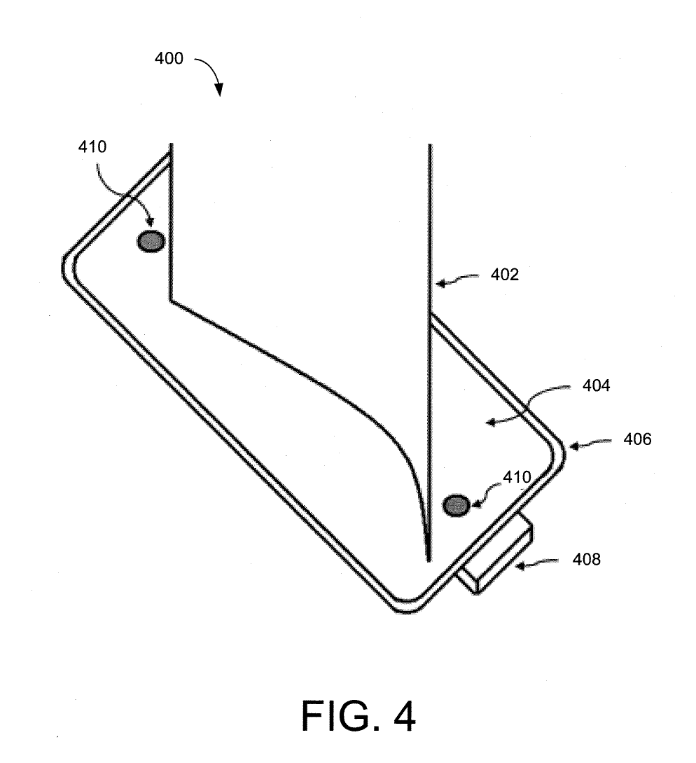

FIG. 4 shows a close up view of rotor blade fastener assembly 400 according to one embodiment. The assembly 400 may be used in connection with a Savonius-style turbine rotor, for example. The rotor blade fastener assembly 400 comprises a rotor blade 402 and rotor blade fastener plate 404 in which an end of the rotor blade 402 is removably seated. The rotor blade fastener plate 404 is in turn seated in a rotor blade fastener plate seat 406. The rotor blade fastener plate 404 and rotor blade fastener plate seat 406 may be fastenable to a rotor arm 408 using one or more fasteners 410, which may be similar or identical to fasteners 306. The design of the rotor blade fastener plate 404 and rotor blade fastener plate seat 406 allows universal attachment of differently-shaped rotor blades while ensuring consistent alignment and balance of the rotor blades 402 relative to the rest of a turbine rotor comprising the rotor blades 402.

In the event that a rotor blade 402 needs to be replaced (e.g., due to damage) or upgraded (e.g., if a new rotor blade design is developed or different operational characteristics are desired), the user may simply remove the one or more fasteners 410 and subsequently remove the rotor blade 402 and rotor blade fastener plate 404 from the rotor arm 408. The rotor blade fastener plate 404 may then be removed from the rotor blade 402 and attached to the new rotor blade 402. The user may then seat the rotor blade fastener plate 404 in the rotor blade fastener plate seat 406 and fasten these components to the rotor arm 408 using the one or more fasteners 410.

### Installation

In embodiments in which the turbine rotor 102 is driven by wind, the apparatus 100 may be mounted to a rooftop, tower or aerial structure suitable for providing access to prevailing winds. In embodiments in which the turbine rotor 102 is driven by water, the apparatus 100 may be mounted to a river or sea bed, floating platform or rigid structure suitable for providing access to prevailing water flows. The apparatus 100 may be plugged into or otherwise electrically coupled to an available power supply (e.g., via a plug connected to the power supply leads 214 that is plugged into an outlet which is in turn connected to a electrical distribution network), and communication to and from the apparatus 100 may be established either through the communication port 120 or using the wireless network adapter 212.

### Startup Procedure

In embodiments utilizing Darrieus or Gorlov-style turbine rotors, the processor-based controller 204 may be programmed such that, upon receiving information from the fluid speed sensor 206 indicating sufficient fluid flow, the processor-based controller 204 causes alternating electric current to be supplied to the induction generator 202 to begin turning the turbine rotor 102. The induction generator 202 may continue to turn the turbine rotor 102 until the turbine rotor 102 has achieved sufficient enough speed so as to begin providing sufficient positive torque to the induction generator 202 so that the flow of electric current supplied to the induction generator 202 is reversed. The induction generator 202 may then begin to supply current back through the power supply leads 214 and back to the power supply (e.g., an electrical distribution network of a public utility company). After the induction generator 202 begins generating, instead of consuming, electrical power, the processor-based controller 204 may enter into an operational monitoring mode.

### Operational Monitoring Mode

When in the operational monitoring mode, the processor-based controller 204 monitors a variety of inputs, including fluid speed, the amount and direction of electrical current being generated (which may be used to compute, by the processor-based controller 204, the amount of electrical power generated or consumed) and generator speed and temperature. Based on a set of pre-programmed operational heuristics, the processor-based controller 204 may select an appropriate operational speed for the induction generator 202 in order to optimize the power output of the apparatus 100. In the event that the fluid speed decreases and the apparatus 100 is no longer able to generate sufficient power, the processor-based controller 204 may initiate a shutdown procedure (discussed below) to bring the turbine rotor 102 to a stop.

### Load Balancing and Auto-Furling

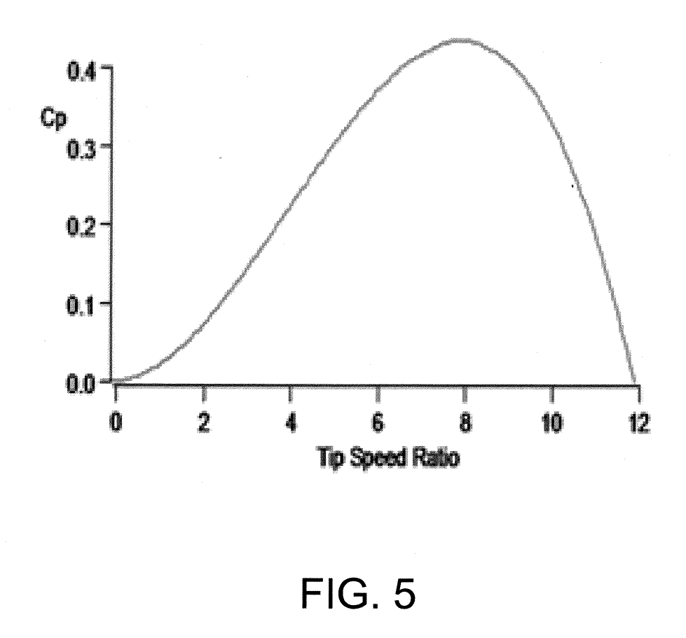

In various embodiments the apparatus 100 automatically adjusts to changes in fluid speed to prevent overloading the generator. FIG. 5 is a power curve illustrating power coefficient values C_{P} as a function of tip speed ratio (TSR) for a typical HAT rotor. TSR is the ratio of the speed of the tips of a turbine rotor to the speed of the fluid. A high TSR indicates that the turbine rotor is traveling at a much higher speed relative to the fluid. Conversely, a low TSR means that the turbine rotor is traveling at a much lower speed relative to the fluid. From the power curve of FIG. 5, it will be appreciated that that as fluid speed increases relative to the speed of the turbine rotor, as is the case during variable fluid speeds such as wind gusts, the turbine rotor blades continue generating considerable lift, often requiring variable pitch blades or furling to avoid overloading a generator attached to the turbine rotor.

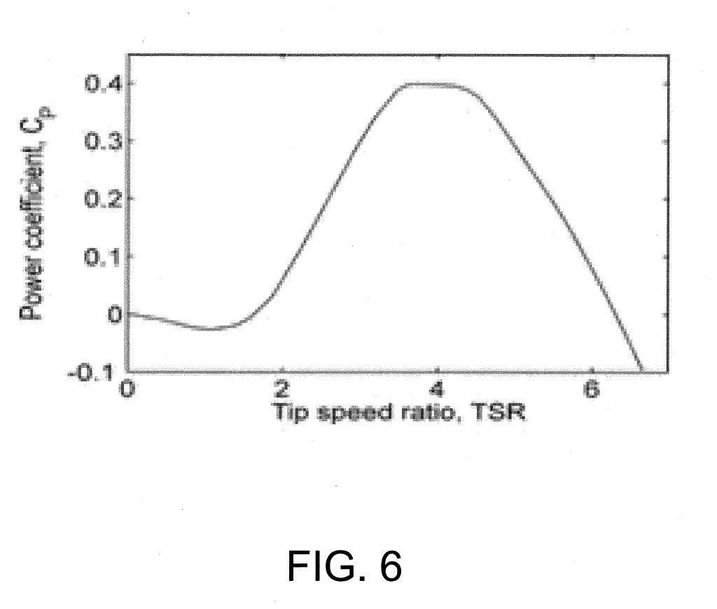

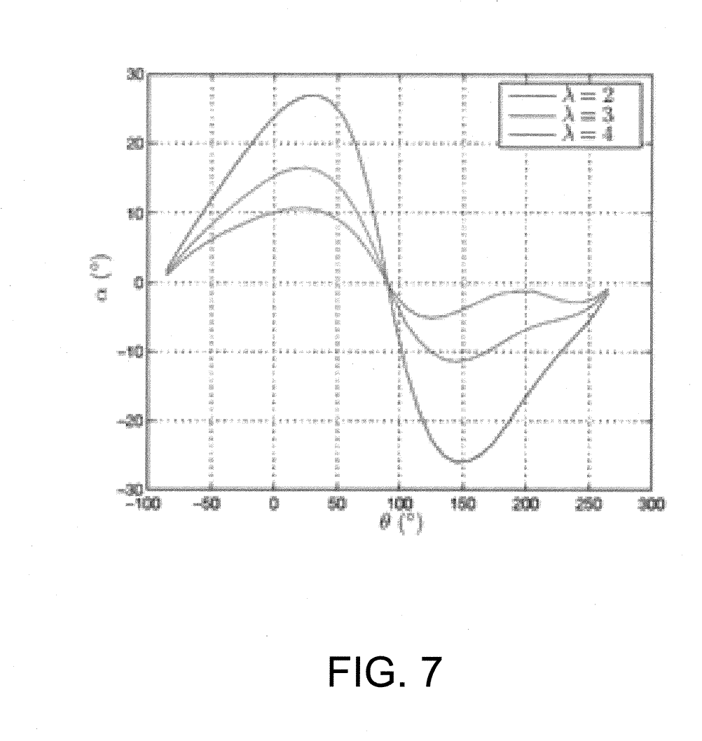

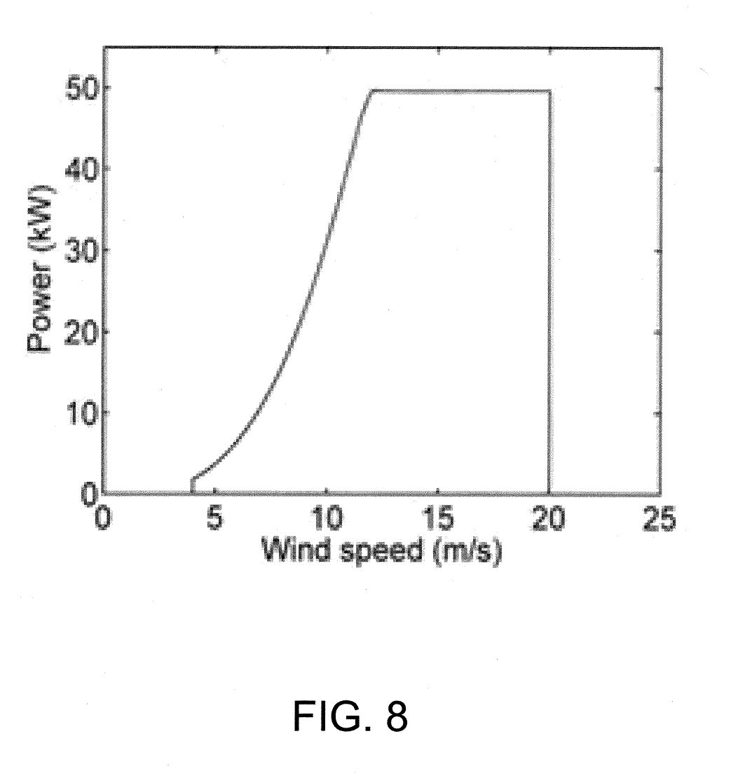

FIG. 6 illustrates a power curve of one embodiment of a VAT rotor. Unlike the power curve of a typical HAT rotor of FIG. 5, the left portion of the curve drops off dramatically during a sudden increase in fluid speed. This results from the fact that the rotor blades rapidly begin to stall at a TSR below 3. FIG. 7 depicts the relationship between TSR (indicated by λ) and the rotor blade angle of attack based on a given position within the rotation of the rotor blade. The maximum angle of attack of the rotor blades in this example is approximately 12 degrees, and it will be appreciated that the angle of attack begins to exceed this maximum at a TSR below 3. Thus, the rotor blades begin to stall and create drag on the rotation of the turbine rotor. The net result is that, unlike a HAT rotor, there is no need to adjust blade pitch for a VAT rotor such as, for example, certain Darrieus, Gorlov or Savonius-style turbine rotors. Instead, in various embodiments the turbine blades “automatically” adjust to changes in fluid speed to prevent an overload of the generator. Moreover, given the torque resistance of the generator, the power output in this example remains substantially constant below λ=3, as illustrated in FIG. 8. It should be noted that the induction generator is not only used for energy conversion, but also to control turbine rotor speed.

It should also be noted in FIG. 6 that for a TSR below 2, the power output is negative. For turbine rotors such as, for example, certain Darrieus or Gorlov-style turbine rotors, self-starting may thus be prevented, even when fluid speeds are high. Without sufficient turbine rotor speed relative to fluid speed, the rotor blades are unable to generate any lift or rotational force and will actually develop negative torque (e.g., rotor blades having a NACA 0018 airfoil shape) and backward spin. This “auto-furling” feature may thus prevent “runaway” operation and is especially during the shutdown procedure and low power operational mode discussed below.

### Shutdown Procedure

Certain conditions may require the shutdown of the apparatus 100. Such conditions may include, for example, high fluid speeds (e.g., high winds, flash flooding) that prevent safe operation of the apparatus 100, disconnection of the apparatus 100 from its power source, a power outage, and insufficient fluid speed for power generation. Under such conditions, the processor-based controller 204 may cause a brief burst of stored DC electrical current (e.g., from a capacitor-based power supply) to be supplied to the induction generator 202, thus causing the induction generator 202 to act as an electric brake and bring the turbine rotor 102 to a stop. After the turbine rotor 102 has come to a rest, the processor-based controller 204 may stop providing DC current to the induction generator 202. If still connected to an operational power source, the processor-based controller 204 may return to operational monitoring mode. If no longer connected to an operational power source, the processor-based controller 204 may return to operational monitoring mode once power has been restored. After the turbine rotor 102 has come to a stop, in embodiments using a Darrieus or Gorlov-style turbine to prevent self starting, the turbine rotor 102 may not begin to rotate again until the processor-based controller 204 initiates the startup procedure.

### Low Power Mode for Excessive Fluid Speeds

In embodiments utilizing certain Darrieus or Gorlov-style turbine rotors, in the event that fluid speed becomes too high for operation within normal operating parameters, the processor-based controller 204 may supply a brief burst of stored DC electrical current to the induction generator 202, causing it to act as an electric brake and bring the turbine rotor 102 to a stop. Once the turbine rotor 102 has come to a complete stop, the processor-based controller 204 then may supply alternating electric current to the induction generator 202 in the opposite direction to begin turning the turbine rotor 102 in the reverse direction. Because Darrieus and Gorlov-style turbine rotors are such that they may supply negative torque at a TSR below a certain level, the induction generator 202 may begin to supply electric current back through the power supply leads 214, at a much lower power output (relative to fluid speed) than in a normal operating mode. Once the induction generator 202 begins generating (instead of consuming) electrical power, the processor-based controller 204 may enter into operational monitoring mode. It will be appreciated that operation of the apparatus 100 in this low-power mode may prevent excessive loading of the induction generator 202.

### Generator Overheating

In the event that the induction generator 202 begins to overheat, the generator temperature sensor 210 may alert the processor-based controller 204, which may in turn initiate the shutdown procedure.

### Configuration and Optimization

In order to configure and/or optimize various operational parameters, the user may connect a computer or other processor-based device to the apparatus 100 either via the communication port 120 and/or the wireless network adapter 212 and subsequently upload and/or upgrade control parameters of the processor-based controller 204. Additionally, various operational parameters such as start up speed, cut off speed and operational profiles (which may comprise one or more power curves, such as the power curve of FIG. 6) also may be configured via the communication port 120, wireless network adapter 212 or a set of hardware dip switches located on the processor-based controller 204.

### Variable Speed Operation and Power Optimization

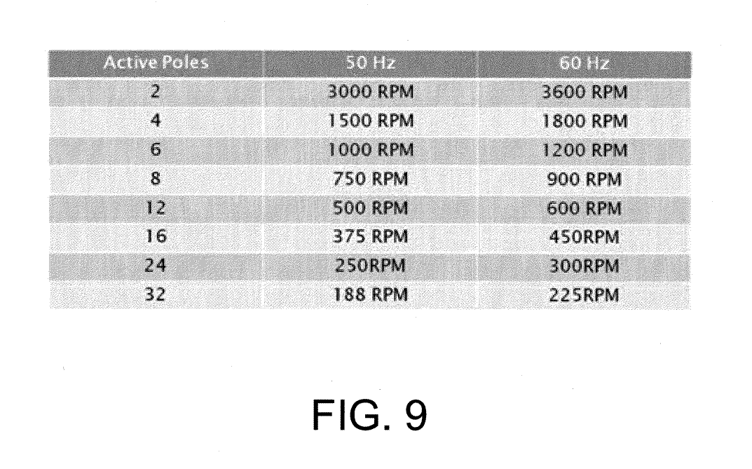

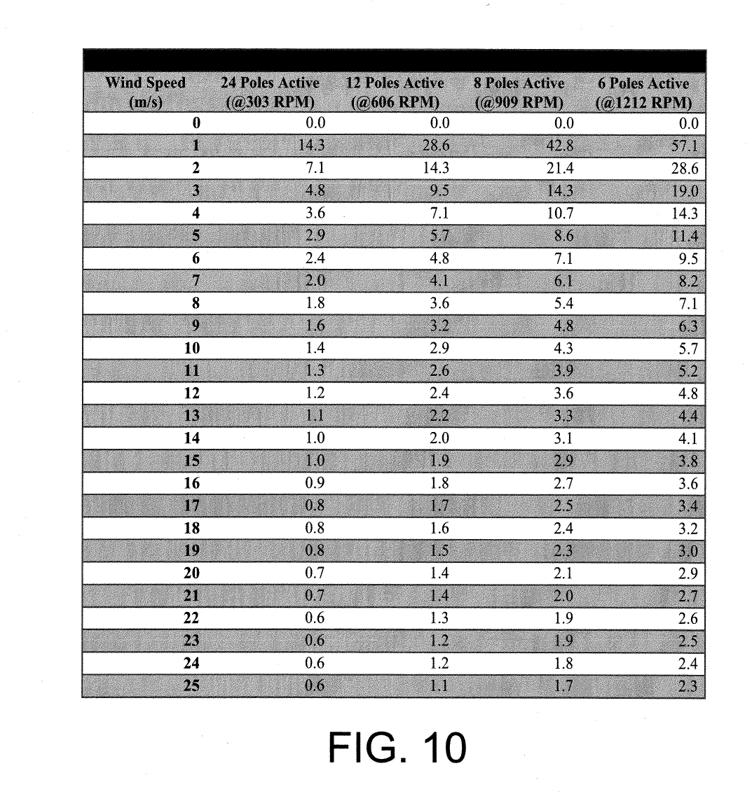

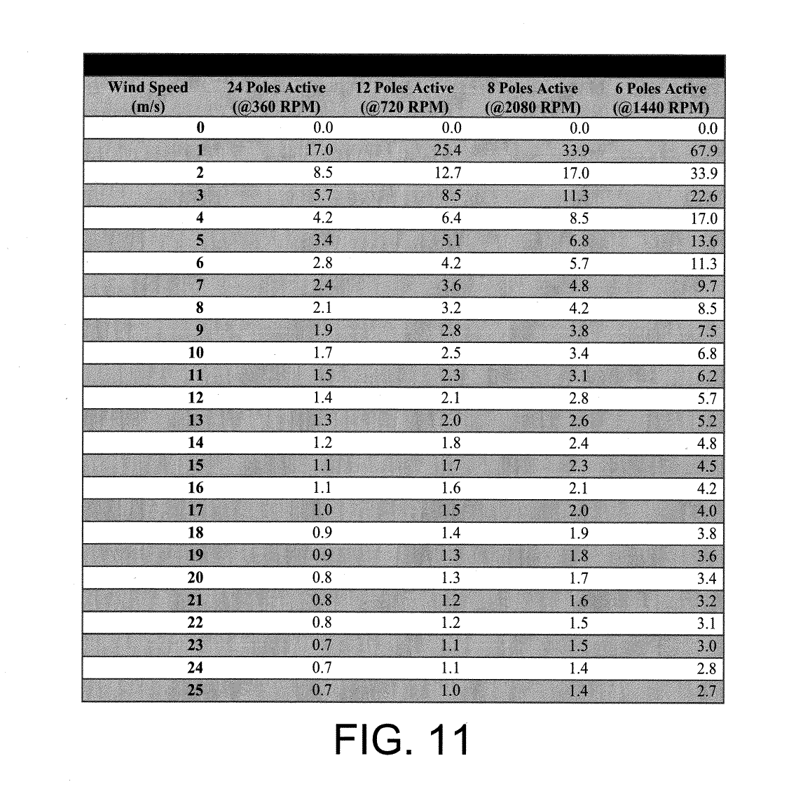

Typically, a generator connected to the local power grid operates at specific rotational speeds that are synchronous with the operation of the local power grid. The table in FIG. 9, for example, illustrates the grid synchronous speed for a given number of active electrical poles within an induction generator, depending on the operational frequency of the power grid (for example, 60 Hz is the operational frequency of the power grid throughout the United States, while the operational frequency in Europe and other areas of the world is 50 Hz). While it is possible to vary the synchronous speed of a generator or by varying the number of active electrical poles during operation (as illustrated in FIG. 9), it can still be somewhat problematic given that fluid speed may be variable. A unique property of an induction generator', however, is that it is able to run at speeds that vary from these grid synchronous speeds. For this reason, induction generators are known as asynchronous generators. The ability to vary from grid synchronous speeds is referred to as generator slip. FIGS. 10 and 11 illustrate different tip speed ratios that are possible for a given number of active electric poles at 1% and 20% slip, respectively. Using this information, in combination with the power output curve of a turbine rotor, pre-programmed heuristics may be developed for optimizing and controlling the power output of the apparatus 100.

In certain embodiments, for example, the induction generator 202 may comprise a number of poles (e.g., 72 poles or 48 poles), and the number of active poles may be adjusted on the fly by the processor-based controller 204 in order to optimize or modify induction generator 202 operation based on, for example, a desired power output of the apparatus 100. The ability to change pole count on the fly is described in, for example, Shelly, Tom, Variable Poles Widen Induction Motor Speeds (Eureka, Jun. 15, 2004), which is incorporated herein by reference. In one such embodiment, for example, the processor-based controller 204 may store one or more predetermined power curves (such as the power curve of FIG. 6, for example) and reference tables such as those shown in FIGS. 10 and 11 for a given turbine rotor and induction generator combination. For a particular speed of the fluid, TSR values possible for each pole count may be determined by referencing tables such as those shown in FIGS. 10 and 11. Such tables may be predetermined and stored in the processor-based controller 204, along with one or more power curves. Accordingly, for a particular fluid speed, the processor-based controller 204 may determine possible TSR values, and, by subsequently referencing a stored power curve, select one of the TSR values and a corresponding pole count which provides a desired power output. The processor-based controller 204 may then change the pole count of the induction generator 202 to obtain a desired or optimal power output. The process of adapting the pole count of the induction generator 202 may be performed continually by the processor-based controller 204 during operation of the apparatus 100 in certain embodiments.

Alternatively or additionally, the processor-based controller 204 may change the pole count of the induction generator 202 responsive to information provided by any of speed sensors 206, 208 and temperature sensor 210. For example, if the processor-based controller 204 determines that a speed is excessive or too low, the processor-based controller 204 may suitably increase or decrease the pole count of the induction generator 202, respectively. Similarly, if the processor-based controller 204 determines that temperature is excessive or too low, the processor-based controller 204 may suitably increase or decrease the pole count of the induction generator 202.

Although control of the apparatus 100 in above-described embodiments is performed locally by the processor-based controller 204, it will be appreciated that in other embodiments such control may be provided by one or more remotely-located control devices (e.g., remotely-located processor based controller(s)) operated by a third party and/or associated with a distributed power generation system comprising a plurality of controllable power resources.

### Service Configuration

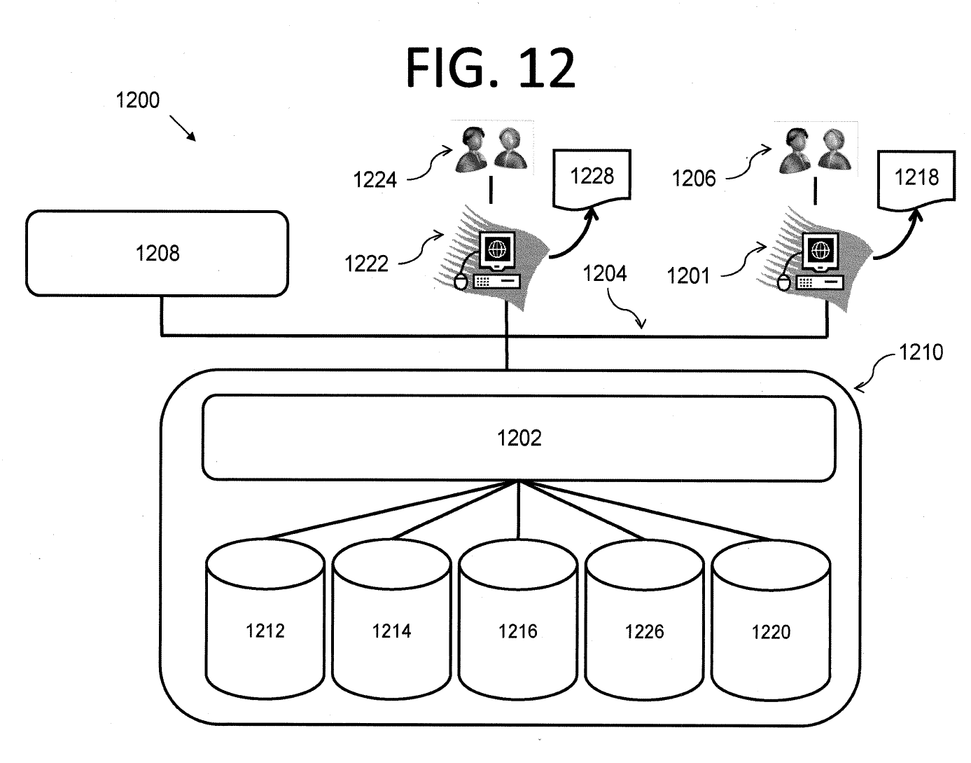

FIG. 12 illustrates a system 1200 for implementing an energy device activation service according to one embodiment. An energy service provider management interface 1201 is connected to an energy device activation service 1202 via a communication network 1204 to enable an energy service provider 1206 to enter, update, edit and/or remove information regarding one or more classes of energy devices 1208 (e.g., a fluid-driven turbine, a solar panel, a hydro-electric generator, a battery storage device, a flywheel, a fuel cell, a gas reformer, a motor, a light bulb, a heater, a radio, a battery charger) that may be connected to an energy service 1210, and to store this information in an approved energy devices database 1212. The connection between the energy service provider management interface 1201 and the energy device activation service 1202 may also enable the energy service provider 1206 to enter, update, edit and/or remove information regarding one or more energy devices 1208 that may be connected to energy service 1210 along with energy device capability information and/or other energy device-related information (e.g., energy device mode), energy device manufacturer, energy rating, system requirements, regulatory requirements), and to store this information in the approved energy devices database 1212. The term “communication network” as used herein includes without limitation one or more of the Internet, a local area network (LAN) and a wide area network (WAN). Communication over the communication network may be effected using, for example, wired technologies such as Ethernet, twisted pair, coaxial cable, optical fiber and energy line communication (PLC) and/or wireless technologies such as Wi-Fi/IEEE 802.11x, Bluetooth, Zigbee, WiMAX, General Packet Radio Service (GPRS), EDGE, CDMA, GSM, microwave, and infrared. Additionally, information may be transmitted as a single stream or Multiplexed to combine multiple analog message signals or digital data streams into a single signal.

In certain embodiments, the energy service provider management interface 1201 may also be used by the energy service provider 1206 to set, update, edit and/or remove one or more business rules that govern connections to the energy service 1210. Such business rules may specify, among other things, one or more classes of energy device 1208 (e.g., solar energy generators, fluid-driven energy generators, battery storage devices) that may be connected to the energy service 1210, and the number of energy devices 1208 of a given class and/or energy rating that may be connected to the energy service 1210 for a given premises, a given property (on which one or more premises may reside), a given distribution point (such as an electrical transformer or electrical substation), a given commercial energy service, or a given system operator (e.g., an entity responsible for operation and control of an electric or gas distribution network for a defined geographic or service area). The energy service provider management interface 1201 may also be used by the energy service provider 1206 to store the business rules in business rules database 1214, to set, update, edit and/or remove one or more requirements (e.g., whether or not on-site inspection is required) for a given class of energy devices 1208 or a given number of energy devices 1208 of a given class or energy rating that can be connected to energy service 1210 for a given premises, a given property, a given distribution point, a given commercial energy service or a given system operator, and to store the requirements in business rules database 1214.

In certain embodiments, the service provider management interface 1201 may also be used by one or more energy service providers 1206 to enter, update, edit and/or remove content (e.g., inspection requirements, connection requirements, consumer agreements, terms of use, end-user license agreements, service contracts, connection agreements) in the agreements and contracts database 1216.

In certain embodiments, the service provider management interface 1201 may also be used by an energy service provider 1206 to retrieve, view and/or print an inventory 1218 of energy devices 1208 connected to a given energy service, a given premises, a given property, a given distribution point, a given commercial energy service or a given system operator from the connected energy devices database 1220.

In certain embodiments, one or more energy management interfaces 1222 may be connected to the energy device activation service 1202 via a communication network, such as the communication network 1204. The term “energy management interface” as used herein refers to an interface which facilitates one or more energy-controllable devices (e.g., an interface to a PAN which facilitates one or more energy-controllable PAN devices, such as a programmable thermostat, a light switch, a solar panel module, a fluid-driven turbine, a plug-in electric vehicle). This energy management interface may reside within a PAN device (e.g., a programmable thermostat, an in-home display, a computer, a cable set-top box, other computing device, etc.), provide auditing/logging functions that record transactions to and from PAN devices, and coordinate the exchange of credentials and operational privileges to activate and connect PAN devices with an energy service program. This energy management interface may also interface with other devices or systems inside or outside the premises to provide integrated automated services for the consumer, and may be controlled by a third party or energy management service.

Each energy management interface 1222 may enable a consumer 1224 to create or manage a consumer account, including without limitation usernames, passwords, account information, name, e-mail, phone, address, zip code, state, country, e-mail and text messaging information, and to store this information in a consumer account database 1226. Each energy management interface 1222 may also enable a consumer 1224 to determine, for example, prior to purchase or installation, whether a given energy device 1208 or class of energy device 1208 may be connected to the energy service 1210, and to retrieve, view and/or print information (e.g., system requirements, regulatory requirements, device capabilities) stored in the approved energy devices database 1212.

In certain embodiments, each energy management interface 1222 may also be used by a consumer 1224 to retrieve, view and/or print an inventory 1228 of energy devices 1208 connected by the consumer to a given energy service, a given premises or a given property from the connected energy devices database 1220.

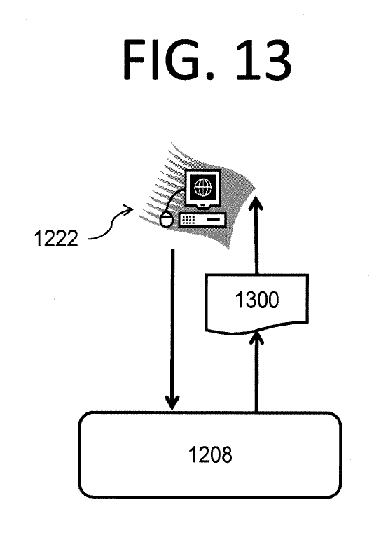

FIG. 13 illustrates communication between an energy device 1208 and an energy management interface 1222 according to one embodiment. In particular, the energy device 1208 may be queried by the energy management interface 1222, and the energy device 1208 may respond by returning a listing 1300 containing operational parameters (e.g., voltage, amps) and energy device capabilities, including without limitation a unique energy device identifier (e.g., a serial number, a MAC ID), an energy rating, an energy capacity, an energy generation enabled status, an energy consumption enabled status, an activation status, a hardware build, a hardware version, a hardware date, a firmware version, a firmware date and a firmware build.

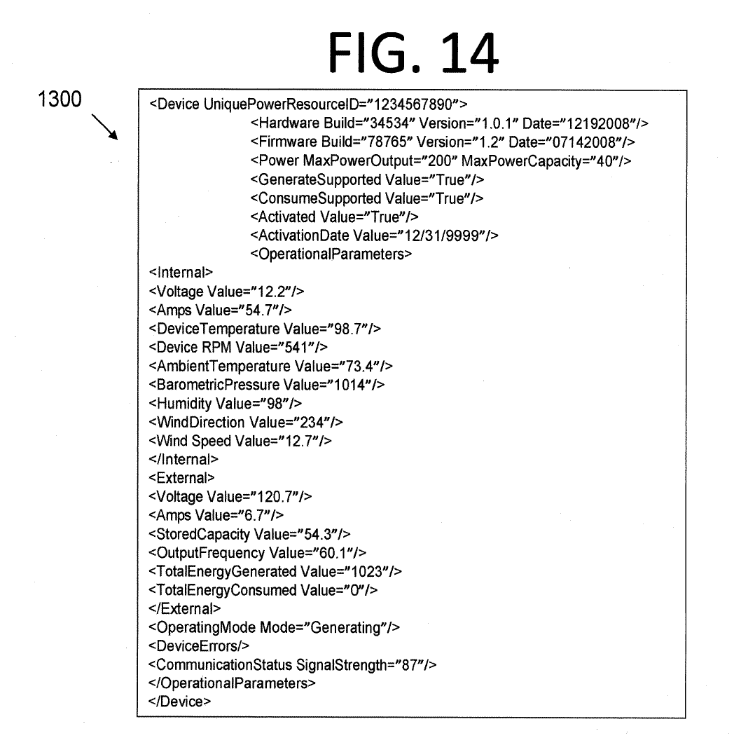

FIG. 14 illustrates a listing 1300 of operational parameters and energy device capabilities returned by an energy device according to one embodiment. As shown, the listing 1300 may be in an XML format.

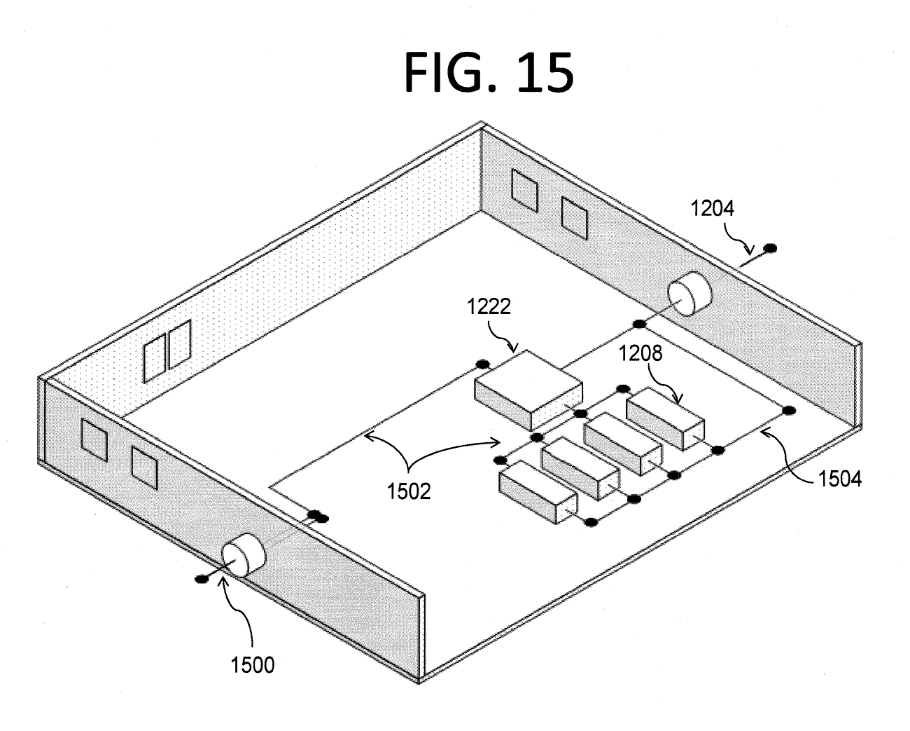

FIG. 15 illustrates a premises area network located within a premises, according to one embodiment. The energy management interface 1222 and each energy device 1208 may be connected to a commercial energy service 1500 via a power bus 1502. The energy management interface 1222 and each energy device 1208 may also be connected to the energy device activation service 1202 (not shown for clarity) via a premises area network 1504 and externally via a communication network, such as the communication network 1204.

### Device Activation

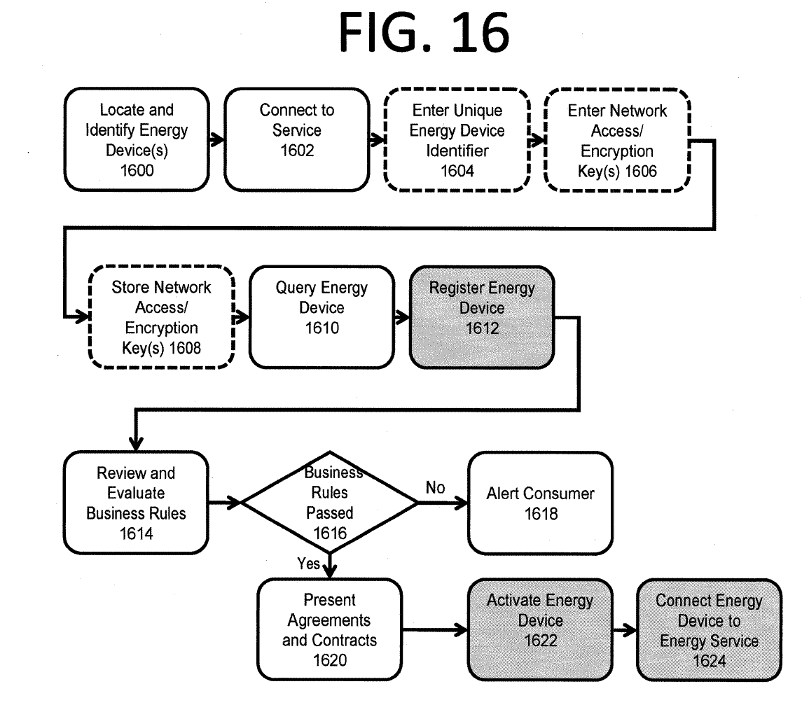

FIG. 16 illustrates an energy device activation workflow for connecting an energy device 1208 to an energy service 1210 according to one embodiment. An energy management interface 1222 locates and identifies 1600 one or more energy devices 1208 on the consumer's premises area network 1504 and connects 1602 to the energy device activation service 1202 using the consumer's login credentials.

In certain embodiments, the energy management interface 1222 may receive 1604 a unique energy device identifier (such as a serial number, a MAC ID) entered by the consumer 1224 to enable confirmation that the consumer 1224 is in possession of each energy device 1208 and that the energy device(s) are not on another consumer's premises area network and/or do not belong to another consumer.

In certain embodiments, the energy management interface 1222 may receive 1606 a network access and/or encryption key(s) entered by the consumer 1224 to enable the connection of their premises area network 1504 to the energy management interface 1222. If required, the energy management interface 1222 may store 1608 network access or encryption key(s) in a non-volatile memory of each energy device 1208 for future use in connecting to the premises area network 1504. The energy management interface 1222 may then query 1610 each energy device 1208 (e.g., as described above in connection with FIG. 13) to determine device-specific information (e.g., device model, device class, energy rating, energy capacity, hardware build, hardware version, hardware date, firmware version, firmware date, firmware build). This information may be stored in the connected energy devices database 1220, thus registering 1612 each energy device 1208 with the consumer 1224.

In certain embodiments, the energy management interface 1222 may conduct a review 1614 with the energy device activation service 1202 to confirm that each energy device 1208 is on the list of approved energy devices (e.g., as set forth in the approved energy devices database 1212) and is eligible for activation according to the business rules stored in business rules database 1214 for a given premises, a given property, a given distribution point (e.g., an electrical transformer or electrical substation), a given commercial energy service or a given system operator. If the energy management interface 1222 determines 1616 that an energy device 1208 does not pass the required business rules and cannot be activated—for example, if the energy device 1208 either individually or collectively with other energy devices 1208 or other consumers' energy devices 1208 exceeds a certain energy rating—the energy management interface 1222 alerts 1618 the consumer 1224 to this issue and provides a full description of the issue along with steps for its resolution. If however, it is determined that each energy device 1208 is an approved energy device and passes 1616 all necessary business rule checks, the energy management interface 1222 may retrieve and present 1620 applicable agreements or contracts (e.g., terms of use, end-user license agreements, service contracts, connection agreements) from the agreements and contracts database 1216 for consumer 1224 review and acceptance. Once any agreements and contracts are accepted, the energy management interface 1222 may then activate 1622 the energy device 1208 to enable it to either generate and/or consume energy by, for example, setting an activation flag to “true,” setting an activation expiration date to a specified date in the future, or by granting an operational certificate which may have an expiration date and contain certain operational privileges to generate and/or consume energy. The activation flag, activation expiration date or operational certificate may be stored in a non-volatile memory of energy device 1208 and undergo evaluation by energy device 1208 during its operation.

In certain embodiments, after the energy device activation workflow is complete, the energy management interface 1222 connects each energy device 1208 to the energy service 1210 via a communication network, such as the communication network 1204, and may store any necessary communication parameters such as IP addresses, access keys or encryption keys required to establish network coordination, assign device addresses and route packets back and forth between the energy device 1208 and the energy service 1210 in the connected energy devices database 1220 and/or in the non-volatile memory of the energy device 1208.

### Device Deactivation

In certain embodiments, an energy service provider 1206 may chose to prevent an energy device 1208 from generating and/or consuming energy, either immediately or at a specified date in the future. This may be effected, for example, by causing an activation flag of the energy device 1208 to be set to “false,” by causing an activation expiration date to be set to a specified date in the future, or by causing revocation of an operational certificate containing certain operational privileges to generate and/or consume energy, upon connection of the energy device 1208 to the energy service 1210.

In certain embodiments, activation and deactivation of an energy device 1208 may include setting the energy device activation flag to either “true” or “false,” setting the activation expiration date to a specified date in the future, exchanging public-private keys that can be compared when setting the energy device activation flag to either “true” or “false” or when setting an activation expiration date to a specified date in the future, or granting or revoking an operational certificate, as described herein.

### General

In certain embodiments, an energy device 1208 may be preconfigured prior to installation (e.g., at a factory or distribution depot) with the energy device activation flag set either to “true,” with the activation expiration date set to a specified date in the future, or with a pre-installed operational certificate to enable the energy device 1208 to either generate and/or consume energy. In this way, the device 1208 may be enabled to either generate and/or consume energy without first activating the energy device 1208 through the energy device activation service 1202.

In certain embodiments, whenever an energy device 1208 is triggered (e.g., when the energy device 1208 is powered on or when a synchronization button located on the energy device 1208 is depressed), the energy device 1208 may provide the energy management interface 1222 with device-specific information (e.g., device model, device class, energy rating, energy capacity, hardware build, hardware version, hardware date, firmware version, firmware date, firmware build) necessary for the energy device activation process. In certain embodiments, such information may be contained in a device certificate that is factory programmed in the energy device 1208. The device certificate may persist for the lifetime of the energy device 1208 or until the energy device 1208 is re-programmed. In some embodiments, an energy device 1208 to be activated by an energy service 1210 may authenticate with the energy device activation service 1202 using the device certificate, and the energy device activation service 1202 may subsequently grant an operational certificate to the energy device 1208 based on its capabilities as presented in the device certificate.

It will be further appreciated that in some embodiments, the above-described process for connecting an energy device 1208 to an energy service 1210 may take place directly between an energy device 1208 and an energy service 1210 without the need for an energy management interface 1222 to serve as an intermediary between the two.

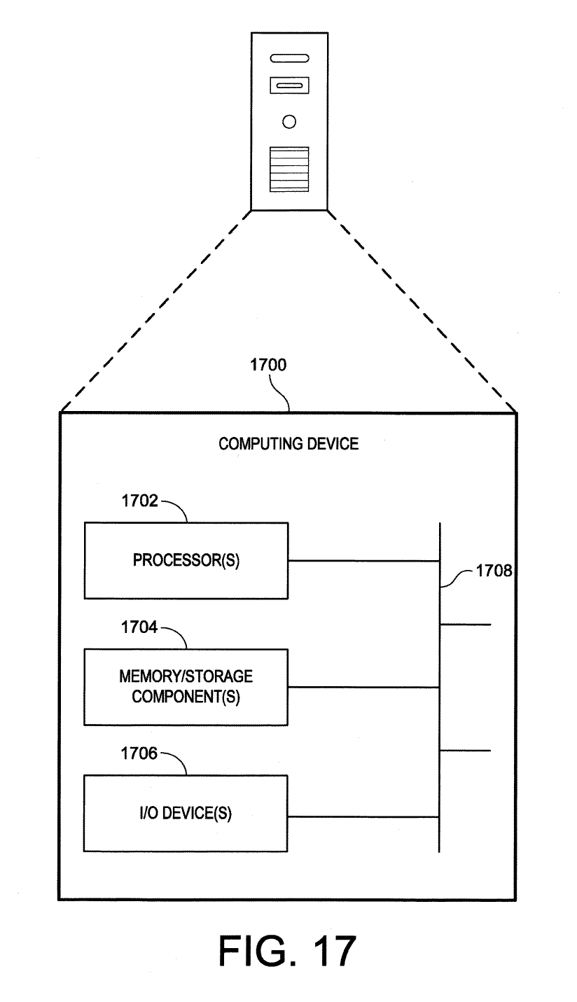

It will be appreciated by one of ordinary skill in the art that at least some of the embodiments described herein or parts thereof may be implemented using hardware, firmware and/or software. The firmware and software may be implemented using any suitable computing device(s). FIG. 17 shows an example of a computing device 1700 according to one embodiment that may be used for implementing, for example, the processor-based controller 204, the energy service provider management interface 1201, the energy service 1210 (including the energy device activation service 1202), and the energy management interface 1222. For the sake of clarity, the computing device 1700 is illustrated and described here in the context of a single computing device. However, it is to be appreciated and understood that any number of suitably configured computing devices 1700 can be used to implement any of the described embodiments. It also will be appreciated that one such device or multiple devices may be shared in a time division multiplex mode among compensators for multiple power amplifiers, as may be the case, for example, in a base station of a mobile communication network. For example, in at least some implementations, multiple communicatively linked computing devices 1700 are used. One or more of these devices may be communicatively linked in any suitable way such as via one or more networks. One or more networks can include, without limitation: the Internet, one or more local area networks (LANs), one or more wide area networks (WANs) or any combination thereof.

In this example, the computing device 1700 may comprise one or more processor circuits or processing units 1702, one or more memory circuits and/or storage circuit component(s) 1704 and one or more input/output (I/O) circuit devices 1706. Additionally, the computing device 1700 comprises a bus 1708 that allows the various circuit components and devices to communicate with one another. The bus 1708 represents one or more of any of several types of bus structures, including a memory bus or, memory controller, a peripheral bus, an accelerated graphics port, and a processor or local bus using any of a variety of bus architectures. The bus 1708 may comprise wired and/or wireless buses.

The processing unit 1702 may be responsible for executing various software programs such as system programs, applications programs, and/or program modules/blocks to provide computing and processing operations for the computing device 1700. The processing unit 1702 may be responsible for performing various voice and data communication operations for the computing device 1700 such as transmitting and receiving voice and data information over one or more wired or wireless communication channels. Although the processing unit 1702 of the computing device 1700 is shown in the context of a single processor architecture, it may be appreciated that the computing device 1700 may use any suitable processor architecture and/or any suitable number of processors in accordance with the described embodiments. In one embodiment, the processing unit 1702 may be implemented using a single integrated processor.

The processing unit 1702 may be implemented as a host central processing unit (CPU) using any suitable processor circuit or logic device (circuit), such as a as a general purpose processor. The processing unit 1702 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 1702 may be coupled to the memory and/or storage component(s) 1704 through the bus 1708. The bus 1708 may comprise any suitable interface and/or bus architecture for allowing the processing unit 1702 to access the memory and/or storage component(s) 1704. Although the memory and/or storage component(s) 1704 may be shown as being separate from the processing unit 1702 for purposes of illustration, it is worthy to note that in various embodiments some portion or the entire memory and/or storage component(s) 1704 may be included on the same integrated circuit as the processing unit 1702. Alternatively, some portion or the entire memory and/or storage component(s) 1704 may be disposed on an integrated circuit or other medium (e.g., hard disk drive) external to the integrated circuit of the processing unit 1702. In various embodiments, the computing device 1700 may comprise an expansion slot to support a multimedia and/or memory card, for example.

The memory and/or storage component(s) 1704 represent one or more computer-readable media. The memory and/or storage component(s) 1704 may be implemented using any computer-readable media capable of storing data such as volatile or non-volatile memory, removable or non-removable memory, erasable or non-erasable memory, writeable or re-writeable memory, and so forth. The memory and/or storage component(s) 1704 may comprise volatile media (e.g., random access memory (RAM)) and/or nonvolatile media (e.g., read only memory (ROM), Flash memory, optical disks, magnetic disks and the like). The memory and/or storage component(s) 1704 may comprise fixed media (e.g., RAM, ROM, a fixed hard drive) as well as removable media (e.g., a Flash memory drive, a removable hard drive, an optical disk). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 1706 may allow a user to enter commands and information to the computing device 1700, and also may allow information to be presented to the user and/or other components or devices. Examples of input devices include data ports, ADCs, DACs, a keyboard, a cursor control device (e.g., a mouse), a microphone, a scanner and the like. Examples of output devices include data ports, ADCs, DACs, a display device (e.g., a monitor or projector, speakers, a printer, a network card). The computing device 1700 may comprise an alphanumeric keypad coupled to the processing unit 1702. The keypad may comprise, for example, a QWERTY key layout and an integrated number dial pad. The computing device 1700 may comprise a display coupled to the processing unit 1702. The display may comprise any suitable visual interface for displaying content to a user of the computing device 1700. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 1702 may be arranged to provide processing or computing resources to the computing device 1700. For example, the processing unit 1702 may be responsible for executing various software programs including system programs such as operating system (OS) and application programs. System programs generally may assist in the running of the computing device 1700 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, Java OS, or other suitable OS in accordance with the described embodiments. The computing device 1700 may comprise other system programs such as device drivers, programming tools, utility programs, software libraries, application programming interfaces (APIs), and on forth.

Various embodiments may be described herein in the general context of computer executable instructions, such as software or program modules/blocks, being executed by a computer. Generally, program modules/blocks include any software element arranged to perform particular operations or implement particular abstract data types. Software can include routines, programs, objects, components, data structures and the like that perform particular tasks or implement particular abstract data types. An implementation of these modules/blocks or components and techniques may be stored on some form of computer-readable media. In this regard, computer-readable media can be any available medium or media used to store information and accessible by a computing device. Some embodiments also may be practiced in distributed computing environments where operations are performed by one or more remote processing devices that are linked through a communication network. In a distributed computing environment, program modules/blocks may be located in both local and remote computer storage media including memory storage devices.

Although some embodiments may be illustrated and described as comprising functional component or modules/blocks performing various operations, it can be appreciated that such components or modules/blocks may be implemented by one or more hardware components, software components, and/or combination thereof. The functional components and/or modules/blocks may be implemented, for example, by logic (e.g., instructions, data, and/or code) to be executed by a logic device (e.g., processor). Such logic may be stored internally or externally to a logic device on one or more types of computer-readable storage media. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSPs), field programmable gate array (FPGA), logic gates, registers, semiconductor devices, chips, microchips, chip sets, and so forth. Examples of software may include software components, programs, applications, computer programs, application programs, system programs, machine programs, operating system software, middleware, firmware, software modules/blocks, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

It also is to be appreciated that the described embodiments illustrate example implementations, and that the functional components and/or modules/blocks may be implemented in various other ways which are consistent with the described embodiments. Furthermore, the operations performed by such components and/or modules/blocks may be combined and/or separated for a given implementation and may be performed by a greater number or fewer number of components and modules/blocks.

It will be further appreciated that retrieval and storage of information in embodiments described herein may be implemented using hardware, firmware and/or software that employ four well-known basic functions of persistent storage: create, read, update and delete, with data transmitted to one or more memory circuits and/or storage circuit component(s) and between computing devices via one or more communications networks.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the embodiments.

What is claimed is:

1. A system for providing an energy device activation service, comprising:
one or more network-enabled energy devices; and
an energy management interface, the energy management interface comprising at least one processor, wherein the energy management interface is to:
establish a network connection with each one of the one or more energy devices via a first communication network;
establish a network connection with an energy device activation service via a second communication network;
query the one or more energy devices to receive at least one of an operational parameter and a capability from each one of the one or more energy devices;
transmit the at least one of an operational parameter and a capability to a first database of the energy device activation service;
determine if each one of the one or more energy devices is an approved energy device based on energy device information stored in a second database of the energy device activation service;
determine if each one of the one or more energy devices is eligible for activation based on at least one business rule stored in a third database of the energy device activation service;
when at least one of the one or more energy devices is determined to be an approved energy device that is eligible for activation, retrieve a contract from a fourth database of the energy device activation service; and
when an acceptance of the contract is received by the energy management interface, activate the at least one approved and eligible energy device to enable at least one of an energy generation feature and an energy consumption feature of the at least one approved and eligible energy device.

2. The system of claim 1, wherein the one or more network-enabled energy devices and the energy management interface are located within a premises, and wherein the energy device activation service is located externally with respect to the premises.

3. The system of claim 1, wherein the first network comprises a premises area network (PAN), and wherein the second network comprises the Internet.

4. The system of claim 1, wherein the energy management interface is to:
create and manage an account associated with the one or more network-enabled energy devices, the account comprising consumer data stored in a fifth database of the energy device activation service.

5. The system of claim 1, comprising an energy service provider management interface in communication with the energy management interface and the energy device activation service via the second communication network, the energy service provider management interface comprising at least one processor, wherein the energy service provider management interface is to:
enter, edit or delete information stored in any of the first, second, third, fourth and fifth databases.

6. The system of claim 5, wherein the energy service provider management interface is to: retrieve, view or print an inventory of the one or more network-enabled energy devices.

7. The system of claim 1, comprising the energy device activation service.

8. The system of claim 7, comprising an energy service, wherein the energy service comprises the energy device activation service.

9. The system of claim 8, wherein the first database comprises data identifying one or more network-enabled energy devices connected to the energy service.

10. The system of claim 8, wherein the second database comprises data identifying one or more network-enabled energy devices eligible for connection to the energy service.

11. The system of claim 8, wherein the at least one business rule comprises a plurality of business rules, the plurality of business rules comprising at least one of:
a business rule specifying one or more energy devices, or one or more classes of energy devices, connectable to the energy service;
a business rule specifying an energy rating requirement of energy devices connectable to the energy service; and
a business rule specifying a number of energy devices connectable to the energy service based on at least one of a premises, a property, a distribution point, an energy service and a system operator.

12. The system of claim 7, wherein the fourth database comprises at least one of a terms of use agreement, an end-user license agreement, a service contract and a connection agreement.

13. The system of claim 7, wherein the fifth database comprises at least one of a consumer name, a consumer username, a consumer password, a consumer e-mail address, a consumer telephone number and a consumer address.

14. The system of claim 1, wherein the energy management interface is to activate each one of the one or more energy devices by setting an activation flag, setting an activation expiration date to a specified date in the future, or granting an operational certificate comprising an expiration date and an operational privilege.

15. The system of claim 1, wherein the energy management interface is to deactivate at least one of the one or more energy devices.

16. A method for providing an energy device activation service, comprising:
establishing, by a energy management interface comprising at least one processor, a network connection between the energy management interface and one or more energy devices via a first communication network;
establishing, by the energy management interface, a network connection between the energy management interface and an energy device activation service, via a second communication network;
querying, by the energy management interface, the one or more energy devices to cause the energy management interface to receive at least one of an operational parameter and a capability from each one of the one or more energy devices;
transmitting, by the energy management interface, the at least one of an operational parameter and a capability to a first database of the energy device activation service;
determining, by the energy management interface, if each one of the one or more energy devices is an approved energy device based on energy device information stored in a second database of the energy device activation service;
determining, by the energy management interface, if each one of the one or more energy devices is eligible for activation based on at least one business rule stored in a third database of the energy device activation service;
when at least one of the one or more energy devices is determined to be an approved energy device that is eligible for activation, retrieving, by the energy management interface, a contract from a fourth database of the energy device activation service; and
when an acceptance of the contract is received by the energy management interface, activating the at least one approved and eligible energy device to enable at least one of an energy generation feature and an energy consumption feature of the at least one approved and eligible energy device.

17. The method of claim 16, comprising creating and managing, by the energy management interface, an account associated with the one or more network-enabled energy devices, the account comprising consumer data stored in a fifth database of the energy device activation service.

18. The method of claim 16, wherein activating comprises setting an activation flag, setting an activation expiration date to a specified date in the future, or granting an operational certificate comprising an expiration date and an operational privilege.

19. The method of claim 16, comprising deactivating, by the energy management interface, at least one of the one or more energy devices.

20. The method of claim 16, wherein determining if each one of the one or more energy devices is eligible for activation based on at least one business rule includes determining based on at least one of:
a business rule specifying one or more energy devices, or one or more classes of energy devices, connectable to the energy service;
a business rule specifying an energy rating requirement of energy devices connectable to the energy service; and
a business rule specifying a number of energy devices connectable to the energy service based on at least one of a premises, a property, a distribution point, an energy service and a system operator.
